(19) United States
(12) Patent Application Publication
(10) Pub. No.: US 2025/0019175 A1
(43) Pub. Date: Jan. 16, 2025

(54) Conveyor Belt Module

(71) Applicant: Rexnord FlatTop Europe B.V., 'S-Gravenzande (NL)

(72) Inventors: Cornelis Hendrik Mijndert Menke, 's-Gravenzande (NL); Andrea Andreoli, Modena (IT)

(21) Appl. No.: 18/711,384

(22) PCT Filed: Nov. 18, 2022
(86) PCT No.: PCT/NL2022/050665

§ 371 Date: May 17, 2024

(30) Foreign Application Priority Data
Nov. 19, 2021 (NL) 2029847

(51) Int. Cl. B65G 17/08; B29C 45/00; B29C 45/16; B29C 45/72; B29K 67/00; B29K 105/26; B29L 31/00

(52) U.S. Cl. CPC B65G 17/08; B29C 45/0001; B29C 45/164; B29C 45/7207; B29K 2067/003; B29K 2105/26; B29K 2995/0039; B29K 2995/0043; B29L 2031/7092

(57) ABSTRACT

A conveyor belt module (1) for a modular conveyor belt having an injection molded body is disclosed that includes recycled PET (rPET) and/or virgin PET. The body (2) comprises a top surface (3) for supporting products to be transported, a bottom surface for sliding over a conveying track, and link elements (7:5) at a front and rear of the body (2) for coupling to a consecutive conveyor belt module. Further, a modular conveyor belt is disclosed, a conveyor system, use of recycled PET (rPET) and/or virgin PET for molding a conveyor belt module for a modular conveyor belt, and a method of manufacturing a conveyor belt module for a modular conveyor belt.

The invention generally relates to the field of conveying, and more specifically to a modular conveyor belt, a conveyor belt module, a method of manufacturing a conveyor belt module, and use of a material to manufacture a conveyor belt module.

Modular conveyor belts are generally known, and are for example used for conveying discrete products, for example packages or bottles. Modular conveyor belts are built up of conveyor belt modules. Due to the modularity, the length of the modular conveyor belt can be varied by placing conveyor modules in a row in a conveying direction, and coupling successive modules in the row. The width of the belt can be varied by placing several modules next to each other transverse to the conveying direction. Modules that are placed in successive rows may be staggered relatively to each other transverse to the conveying direction so as to form a conveyor mat having a brick laid pattern. A modular conveyor belt having a single row of modules is typically called a conveyor chain.

Modular conveyor belts are usually of endless design, so that a top run of the modular conveyor belt can circulate over a conveying track that extends in a conveying direction between return elements. A bottom run of the modular conveyor belt can circulate over a return track that extends in opposite direction between the return elements. The return elements may be formed by return guides or return wheels, usually a set of sprocket wheels. Sprocket wheels may be provided with teeth that engage the bottom of the modular belt, e.g. at a drive pocket provided in a bottom surface of the conveyor belt module, and may be used to drive the modular conveyor belt.

Conveyor belt modules for modular conveyor belts typically have a module body with a top surface for supporting products to be transported, and a bottom surface for sliding over a conveying track. The module bodies are typically provided with link elements (also called coupling elements herein) at the front and rear with which successive module bodies may be coupled so that top surfaces of conveyor belt modules in the top run can jointly form a conveying plane. Consecutive modules may be hingedly coupled about an axis in or parallel to the conveying plane transversely to the conveying direction so that the modules can rotate relative to each other to pass along the return element. The link elements may extend outward from a central portion of the body, in conveying direction at the front, and in opposite direction at the rear. For modular conveyor chains, the link elements may be located below the central portion. The link elements may be interspaced transversely to the conveying direction, such that link elements of successive modules may interdigitate. The link elements may be provided with aligned hinge openings in the link elements, so that successive modules may be coupled with hinge pins that extend transversely to the conveying direction through the hinge openings. Consecutive modules may further be hingedly coupled about an axis perpendicular to the conveying plane so that the modules can rotate relative to each other to pass along a bend in the conveying track.

Conveyor belt modules are usually manufactured by molding, and are often manufactured from a plastics material. The conveyor belt modules are typically made out of thermoplastic material, and are typically integrally formed in one piece in a mold by injection molding. Conveyor belt modules are in practice made of semi crystalline engineering plastics having a relatively high speed of crystallization, such as PA, PBT, POM, PE or PP. The use of these engineering plastics allows the modular conveyor belts to be of relatively light weight, of relatively high strength and of relatively high resistance to wear. Depending on the desired material characteristics of the conveyor belt module to be formed, any of the above listed materials may be selected to injection mold conveyor belt modules from the same cavity of the same injection molding tool.

Although very satisfactory in many regards, a disadvantage of the present conveyor belts is that conveyor belt modules are typically molded at least substantially from virgin material and use of recycled material is limited. Recycled material of the above mentioned plastics typically has material characteristics that have degraded significantly compared to virgin material, e.g. molecular chains that have shortened due to previous thermal processing of the material. In addition, the grade and purity of the recycled material often varies, which may cause a significant disturbance of the processing parameters, and hence disturbance of process control. This is in particular the case when use is made of so called postconsumer recycled material, which-compared to recycled industrial scrap material—is more readily available and less expensive. In practice, the use of a significant amount of recycled material may e.g. lead to fluctuation in viscosity of the material in its molten state and hence fluctuation in mold flow, cycle time and/or distortions in the molded products, such as sink marked or warped product surfaces. Molding modules from mostly virgin material has negative environmental impact, and is relatively costly.

An object of the invention therefore is to mitigate the above mentioned drawback, preferably while at least substantially maintaining or improving the advantages. In particular, the invention aims to provide a modular conveyor belt, a conveyor belt module, a method of manufacturing a conveyor belt module, and a material to manufacture a conveyor belt module with which the use of virgin material may be reduced, and in which the use of recycled material is increased. In addition, the invention aims to provide such increased use of recycled material while lowering environmental impact.

Thereto the invention provides for a conveyor belt module having an injection molded body that includes recycled PET (rPET). It has been found that conveyor belt modules may be successfully molded at least substantially from rPET, in particular at least 30 or 40 weight % of rPET, specifically more than 50 weight % of rPET and in particular more than 60 weight % of rPET. Molding the conveyor belt modules may be done without significant loss of mechanical properties compared to virgin PET, and while obtaining suitable mechanical characteristics for a conveyor belt module. In particular, a conveyor belt module for a modular conveyor belt is provided, comprising an injection molded body with a top surface for supporting products to be transported, a bottom surface for sliding over a conveying track, and link elements at a front and rear of the body for coupling to a consecutive conveyor belt module, wherein the injection molded body includes recycled PET (rPET). These advantages in practice offset the disadvantages of the use of a dedicated mold.

It is observed that (virgin) PET is in practice not used for molding conveyor belt modules as its shrinkage and cooling characteristics require the use of dedicated molds. In view of the modular character of modular conveyor belts, PET can thus not be used to injection mold conveyor belt modules interchangeably from the same cavity of the same injection molding tool as engineering plastics commonly used for molding conveyor belt modules such as PA, PBT, POM, PE or PP. Rather the size of the mold cavity and the configuration of the cooling system needs to be adapted for PET.

Further, process control for injection molding with PET is relatively complex as it has a relatively low speed of crystallization, while the advantages of its transparent amorphous phase that normally offset these disadvantages for other products are not relevant for conveyor belt modules. In addition, the relatively high brittleness of the crystalline phase present a challenge for use in a conveyor belt module.

However, it has been found that the relatively low speed of crystallization of PET provides more flexibility to adapt the process control parameter to disturbances caused by the variations of grade and purity that are inherent to the use of a recycled material, in particular a postconsumer recycled material. In addition, it has been found that rPET is available with relative constant grade and purity at relatively low costs, which in itself reduces the variation in process control.

The semi crystalline PET material of the conveyor belt module can be molded to present a varying degree of crystallinity across its body. The conveyor belt module body is preferably solid in the sense of having a material structure that is free of voids such as in a foam. In particular the body can comprise a core having a relatively high average degree of 10 crystallization, and an outer cover layer of a relatively low average degree of crystallization. The material of the core can then have a relatively high average degree of crystallization and can be less amorphous, while the material of the cover layer can form a skin having a relatively low average degree of crystallization and can be more amorphous. Preferably, the outer cover layer is substantially amorphous, e.g. having an average degree of crystallinity of less than 10%, in particular less than 5% or less than 3%, for example in the range of 2-5%. Preferably, the core is more crystalline than the outer cover layer, e.g. having an average degree of crystallinity of at least 5%. Still, the average degree of crystallinity of the core is preferably less than 20% or less than 10%, for example in the range of 5-10%. Due to the nature of PET, the above described degrees of crystallinity of the core and the outer cover layer may result in the outer cover layer being relatively transparent, at least when the body is free of pigments, while the core can be relatively opaque. Between the outer cover layer and the core typically a transient zone may be present in which the crystallinity gradually increases radially inward from the outer surface of the module body towards the core. The degree of crystallinity or crystallization of the PET material may be determined by a conventional calorimetric analysis method.

As a result, the core of the body can be relatively hard and brittle, while the outer layer can be relatively ductile and tough. Compared to conventional conveyor belt modules of fast crystallizing semi crystalline engineering plastics such as PA, PBT, POM, PE or PP, the layer forms a skin can be relatively thick, and may e.g. have a minimum thickness of at least 1 mm, preferably at least 2 mm, and/or an average thickness of e.g. at least 1.5 mm. The outer layer may be formed by providing enhanced cooling in the molding tool, e.g. additional cooling channels.

When the coupling elements (also called link elements herein) are molded to be substantially amorphous and/or have a relatively low average degree of crystallization, e.g. less than 30 or 10%, they can be made to be relatively tough and ductile so as to increase their capacity to withstand impact loads imparted during conveying or during assembly. Such coupling elements may be obtained by providing local further enhanced cooling in the molding tool, e.g. additional dedicated cooling channels near the areas of the mold cavity in which the coupling elements are formed, and/or by cooling core elements that form hinge openings in the coupling elements.

When the core, at least one or more sections thereof, extends between the link elements in a front-rear direction corresponding to a conveying direction, an advantageous stiffening of the module can be realized, in particular so as to inhibit undesired stretching of the module along the conveying direction. It shall be appreciated that when core or a section thereof extends between the link elements, the core or section may or may not extend up to any, some or all of the link elements, and the same core or section may additionally extend into one or more of the link elements.

When the core, at least a section thereof, forms a stiffener extending between the link elements in the front-rear direction, a disadvantageous stretching of the module in the conveying direction can be inhibited.

When along a transverse, in particular sideways, direction of the module the stiffener is arranged centrally with respect to the link elements, in particular being formed substantially symmetrically with respect to a central plane extending in front-rear and top-bottom directions, a loading of the stiffener during use can be relatively well balanced, in particular also when a conveyor belt comprising the module runs along a sideways curved path.

When the stiffener extends into one of the link elements, in particular a central link element, the stiffener can be relatively rigidly coupled to a hinge pin extending through such a link element.

When the stiffener is embedded in a connecting structure that interconnects at least two, preferably at least three and/or each, of the link elements, force transmission between the link elements via the stiffener can be promoted, in particular so that stretching and/or deformation of the module during use can be inhibited.

When the connecting structure comprises mutually interconnected connecting ribs connected to respective ones of the link elements, a relatively lean yet effective connecting structure can be provided, in particular a relatively low degree of crystallization apart from the stiffener.

When, compared to the stiffener, the rest of the connecting structure is substantially amorphous and/or has a relatively low average degree of crystallization, e.g. less than 10%, less than 5% or even less than 3%, 2% or 1%, the connecting structure can be relatively tough, in particular resistant to load variations and impacts during use. Moreover, since the stiffener is embedded in the connecting structure, the connecting structure can thus advantageously protect the stiffener from being damaged by such loads, or at least the connecting structure can suppress disintegration of the stiffener when damage does occur, so that the stiffener can at least partly continue to perform its stiffening function, and breakage of the module can be prevented.

When, compared to the stiffener, the rest of the body is substantially amorphous and/or has a relatively low average degree of crystallization, e.g. less than 10% or less than 5%, or even less than 3%, 2% or 1% the body can be relatively ductile, tough and wear resistant, in particular resistant to load variations and impacts during use.

Thus, in some embodiments, the body may be considered as consisting of the core forming the stiffener and the outer cover layer forming the rest of the body, wherein some sections of the outer cover layer may extend relatively far from the core and/or wherein the core is a relatively localized core embedded in a body that is substantially formed by the outer cover layer. In some embodiments, multiple of such cores or core portions could be present, e.g. distributed with interspace along a sideways direction of the module. While the outer cover layer covers, and preferably embeds, the core or cores, part of a core could be exposed, i.e. not being covered by the cover layer.

When the stiffener, and preferably the connecting structure, is formed on a bottom side of the module, in particular along a bottom face that is recessed with respect to lateral outer body sections forming a bottom surface for sliding over a conveying track, and/or with respect to the link elements, the top surface can remain substantially flat while the body can have a relatively small general thickness, e.g. a thickness of about 2 mm, between the top surface and the recessed bottom face, in turn facilitating injection molding the conveyor belt module with a low general degree of crystallization, e.g. less than 3%, less than 2% or less than 1%, apart from the core and/or stiffener. Meanwhile, a height of the lateral outer body sections can be chosen to achieve a desired height level of the top surface with respect to a support surface of a conveying track on which the modules are supported during use, for example corresponding to a standard height, such as 4 mm. Contrary to conventional modules, the module may thus be supported on the conveying track only via such lateral outer body sections, which may together form the bottom surface that slides over the track during use. An area of the bottom surface may then be particularly small compared to the area of the top surface, for example less than 15%, less than 10%, or less than 5% of the top surface area. Meanwhile, thanks to the use of substantially amorphous PET including in the lateral outer body sections, wear of the bottom surface can remain at an acceptably low level. In conventional modules made from different materials, such a small area for the bottom surface would result in excessive wear.

It is noted that the above described aspect of amorphous PET based lateral outer body sections enabling a relatively small surface area of the bottom surface and thus a relatively lean and lightweight module, may also be applied independently from other aspects disclosed herein. Thus, an aspect of the present disclosure provides a conveyor belt module for a modular conveyor belt having an injection molded body that includes PET, wherein a bottom surface for supporting the module on a conveying track is formed by lateral outer body sections of substantially amorphous PET, wherein the lateral outer body sections are dimensioned so that the bottom surface has an area that corresponds to less than 15% of an area of a product receiving top surface of the module, preferably less than 10%, more preferably less than 5%.

When, apart from the core and/or the stiffener, link elements are substantially amorphous and/or have a relatively low average degree of crystallization, in particular compared to the core and/or the stiffener, e.g. a degree of crystallization of less than 10%, less than 5% or even less than 3%, 2% or 1%, the link elements can be relatively ductile, tough and resistant to load variation and impacts during use.

When the top surface of the body is molded to have a low friction contact surface, i.e. a surface presenting a relatively high degree of surface irregularities and/or texturing, in particular compared to a smoothly molded surface, a contact surface area between the top surface and any products placed thereon can be reduced, in particular to facilitate relatively smooth and easy sliding of such products over the top surface. Such a low friction contact surface is known per se, and is described in e.g. WO 96/41759 and DE 102011114250. To alleviate the disadvantage of loss of effect of the low friction contact surface due to wear and fouling, the PET low friction contact surface may be reconditioned by remolding the top surface. Remolding the top surface may be carried out by heating the PET material of the top surface of the conveyor belt module to above its glass transition temperature, which is typically about 75° C., e.g. preferably to about 100° C. and specifically to below 120° C., wherein the top surface may be remolded, e.g. using a heat source and a textured mold surface, e.g. a plate or roller. Such remolding may be carried out in situ on the conveyor belt modules of an assembled conveyor belt that remains installed in its conveyor.

The rPET material used for molding may originate from recycled PET bottles, in particular postconsumer recycled bottles. The rPET material may be rPET flakes, obtained from shredded recycled PET postconsumer bottles. Since the PET bottles are typically molded from a same type of PET, the re-use of postconsumer bottles yield rPET which is relatively uniform in its molecular weight, i.e. length of the polymer molecule. It is therefore relatively uniform in its viscosity when it is in its molten state during injection molding. In addition, due to the transparency of bottles, rPET from recycled bottles have a relatively low crystallinity. This means that the material requires relatively little heat to melt compared to relatively amorphous rPET material, e.g. regranulated rPET material. The flakes of postconsumer rPET bottles may be fed into the feed screw of an injection molding machine, i.e. without need of regranulation. This allows the use of recycled material for the conveyor belt modules with relatively small environmental impact. Regarding the use of rPET, it is observed that thorough drying of the rPET material before injection molding facilitates processing, and is especially recommended for rPET flakes. Also more generally, it shall be appreciated that it is important for PET material to be dry before injection molding.

It is observed that (postconsumer) rPET material of very low grade and low purity may need addition of relatively high percentage of virgin (PET) material to stabilize processing and safeguard mechanical properties of the conveyor belt modules, e.g. 10-20 weight % of rPET material and 80-90 weight % of virgin PET material. However, as such postconsumer rPET material has little use and is very inexpensive, it may from both a commercial and environmental perspective still be attractive to use it for molding conveyor belt modules even in such low proportions.

Nevertheless, in view of the advantages of a conveyor belt module having an injection molded body that includes PET, it shall be appreciated that in some scenarios it may be acceptable or even preferred to use only virgin PET and no rPET, for example depending on fluctuations in availability and/or pricing of such materials. Thus, where the present disclosure refers only to rPET, this may generally be substituted or complemented by virgin PET, except where the respective part of the description implies differently. The invention therefore provides for a conveyor belt module having an injection molded body that includes PET, i.e. a conveyor belt module for a modular conveyor belt having an injection molded body that includes recycled PET (rPET) and/or virgin PET. The PET material of the conveyor belt module can advantageously be solid and/or can be molded to present a varying degree of crystallinity across its body.

The conveyor belt modules may be molded from conventional pellets of PET material, e.g. single color pellets of virgin PET material or rPET material or a mixture thereof. The conveyor belt modules may be molded from multicolor flakes, which are available at relatively low cost. A pigment may be added to the rPET flakes, e.g. a dark pigment to make the body of the conveyor belt module uniform in color and/or substantially opaque. In particular, the pigment used to color the body may e.g. include white, green, yellow, brown, blue, red, purple or black.

The recycled PET bottle material may be processed without need for adding nucleating agent. If desired, the mechanical properties of rPET may be enhanced, e.g. by adding fibers and/or copolymers.

The invention further relates to a modular conveyor belt comprising a row of modules extending in conveying direction, wherein successive modules are hingedly coupled about an axis in or parallel to a conveying plane transversely to the conveying direction so that the modules can rotate relative to each other, said row of modules comprising one or more modules as discussed above.

The invention further relates to a conveyor belt system including a modular conveyor belt as discussed above in which the conveyor belt modules are coupled to form an endless loop, and wherein a top run of the modular conveyor belt is arranged to circulate over a conveying track that extends in a conveying direction between return elements, and wherein a bottom run of the modular conveyor belt is arranged to circulate over a return track that extends in opposite direction between the return elements.

The invention further relates to the use of recycled PET (rPET) for molding a conveyor belt module for a modular conveyor belt, in particular a conveyor belt module as discussed above.

The invention further relates to method of manufacturing a conveyor belt module for a modular conveyor belt, in particular a conveyor belt module as discussed above, in which recycled PET (rPET) is injected in a mold cavity to form a body of the module.

It should be noted that within the context of the invention, the features disclosed above may each be isolated from their context, and/or may be combined.

Further embodiments of the invention are set out in the appended claims.

The invention will be further elucidated on the basis of non-limiting exemplary embodiments, which are represented in the drawings. In the drawings:

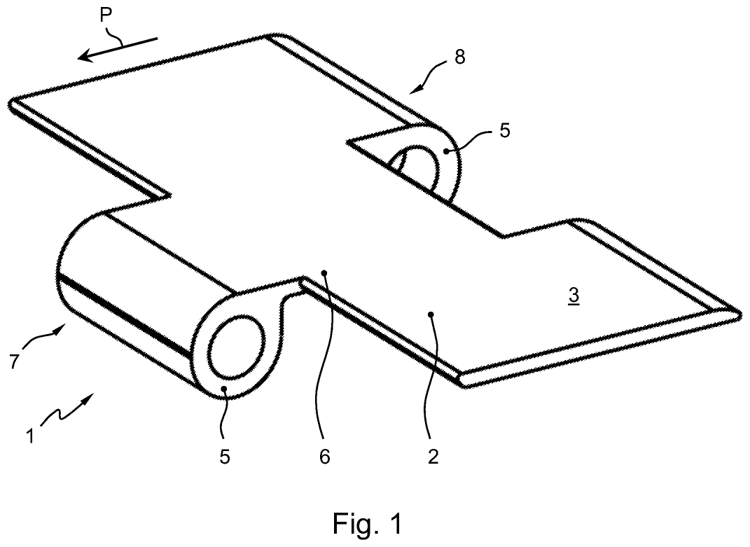

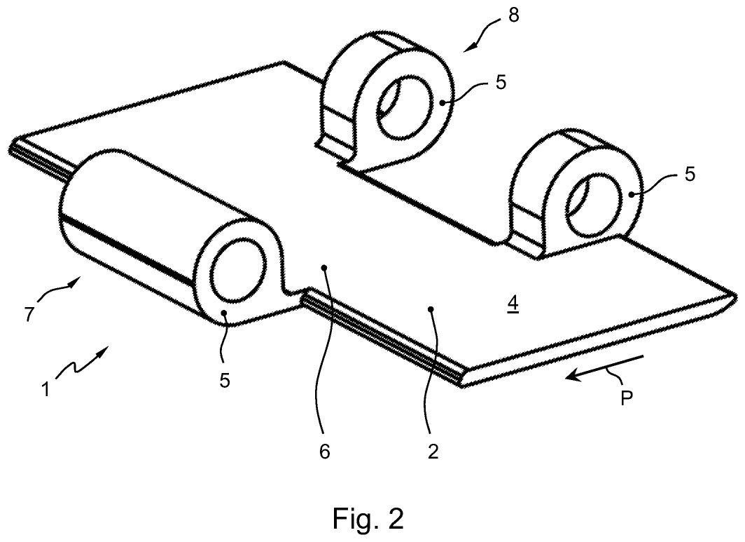

FIG. 1 shows a schematic perspective top view of a conveyor belt module for a modular conveyor mat according to a first embodiment of the invention;

FIG. 2 shows a schematic bottom view of the module of FIG. 1;

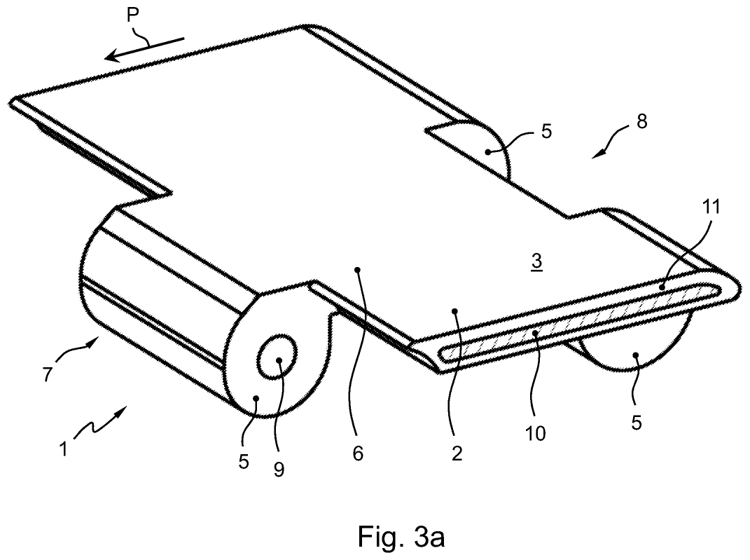

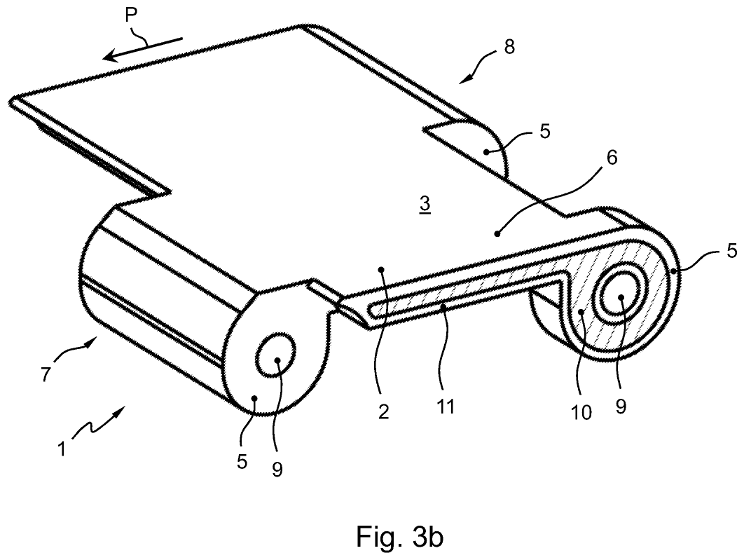

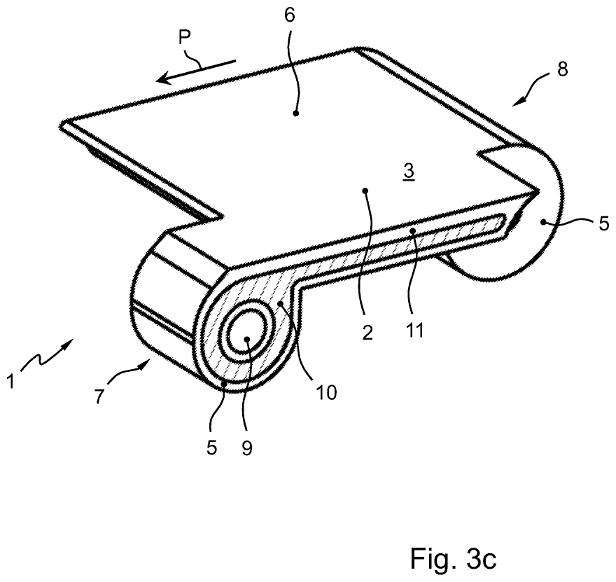

FIGS. 3a, 3b and 3c each show a longitudinal cross section of the module of FIG. 1 at different locations across the width of the module;

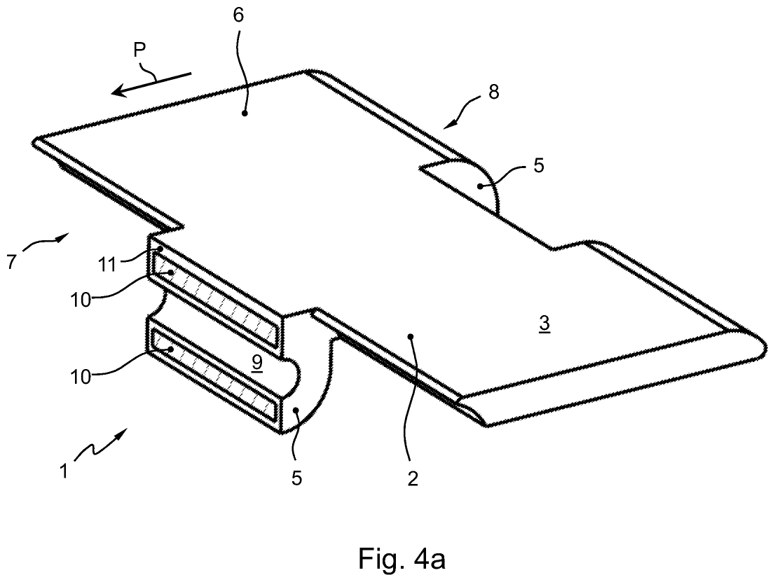

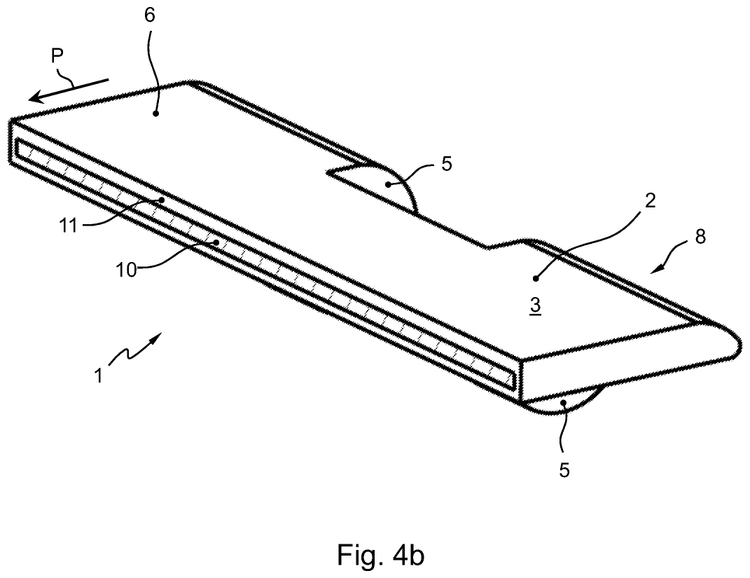

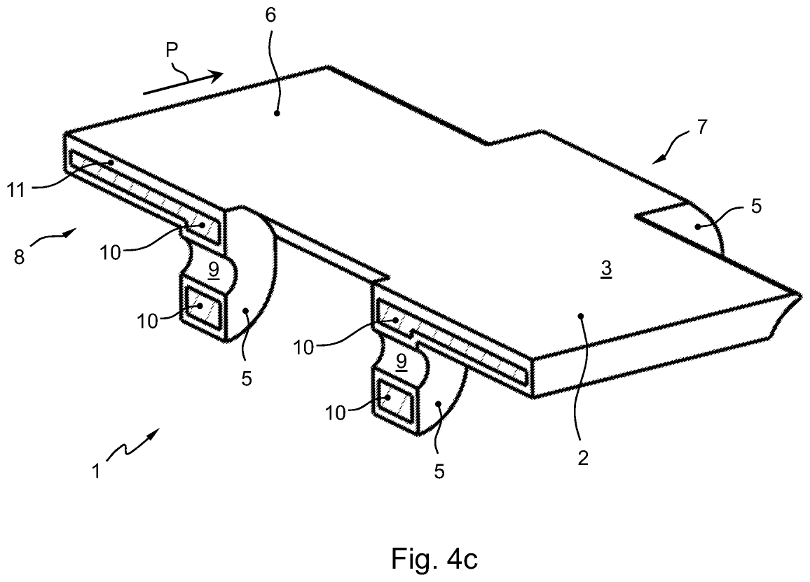

FIGS. 4a, 4b and 4c each show a transversal cross section of the module of FIG. 1 at different locations across the length the module;

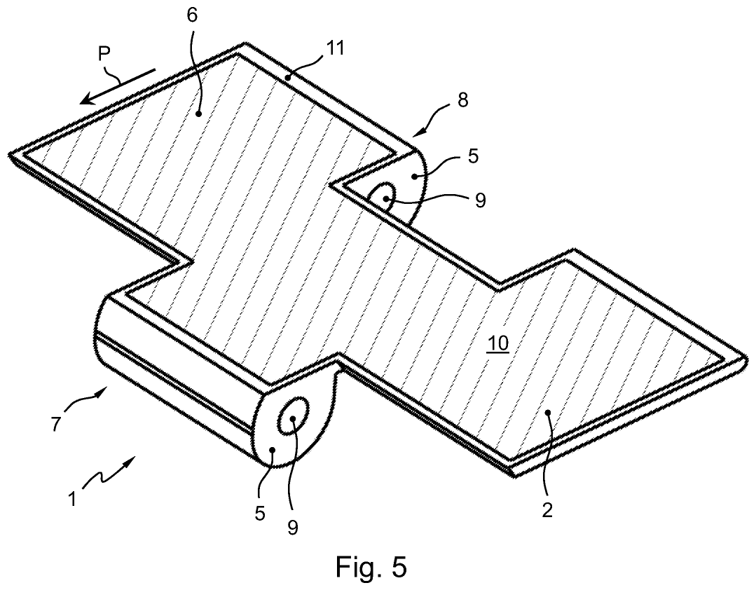

FIG. 5 a planar cross section of the module of FIG. 1 below a top surface of the module,

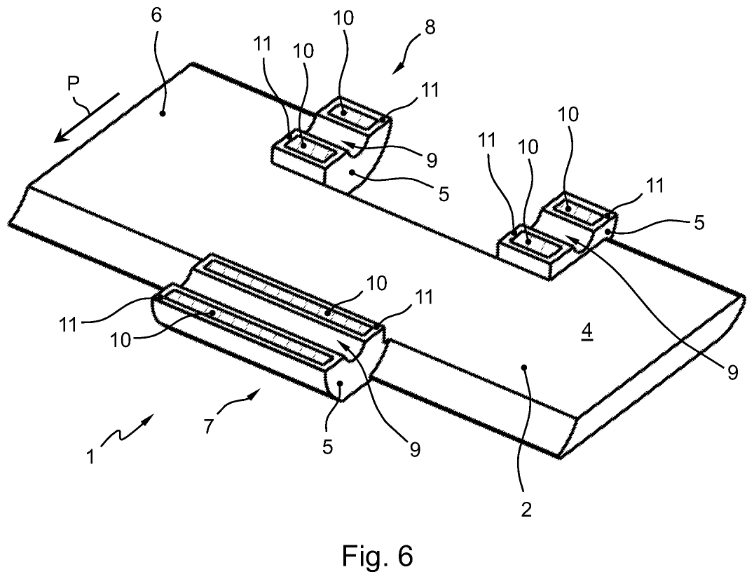

FIG. 6 a planar cross section of the module depicted in FIG. 2 above a bottom portion of the module;

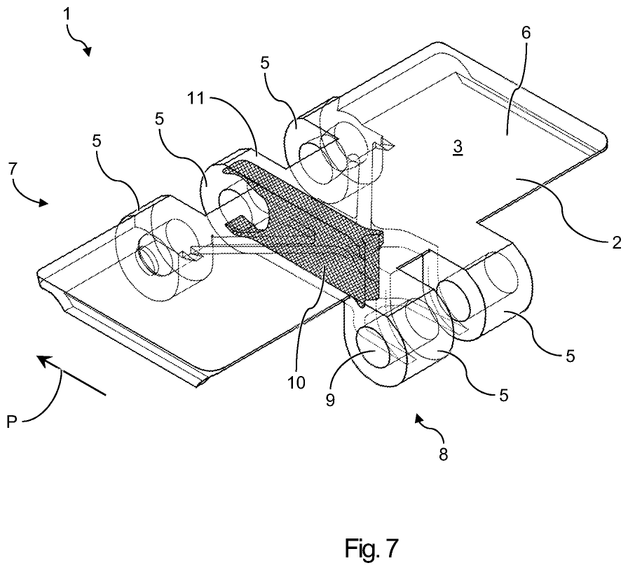

FIG. 7 shows a schematic partly transparent perspective top view of a conveyor belt module according to a second embodiment;

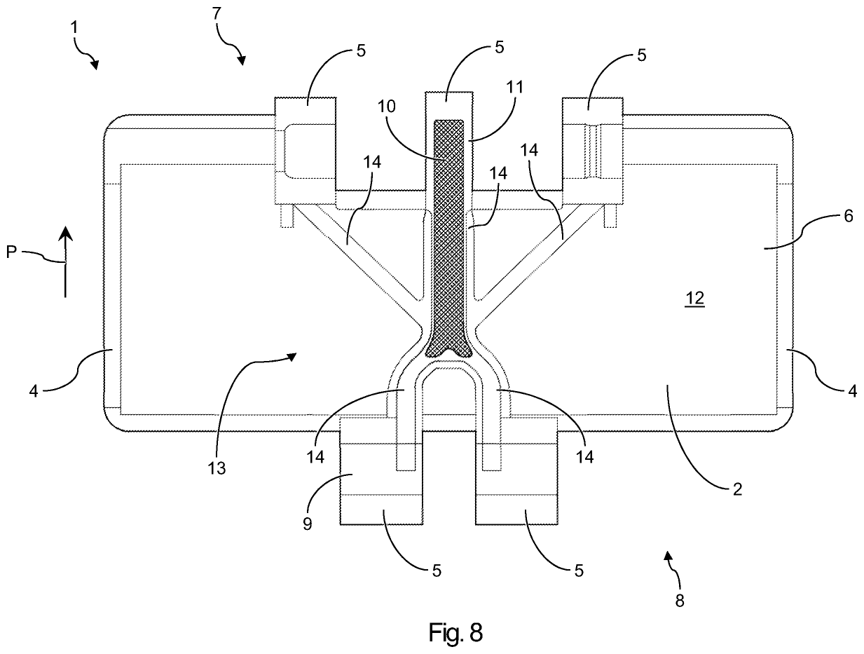

FIG. 8 shows a schematic partly transparent bottom view of the module of FIG. 7;

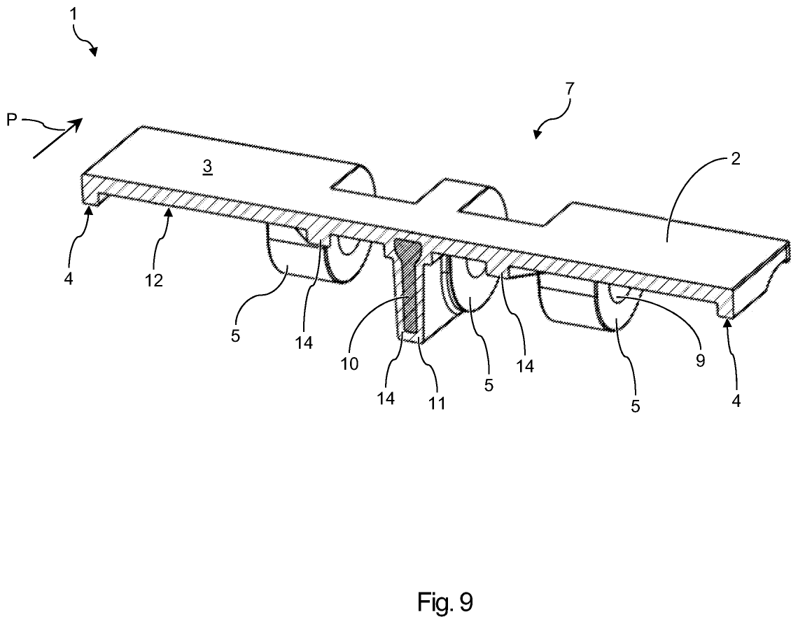

FIG. 9 shows a schematic perspective top view of a transversal cross section of the module of FIG. 7;

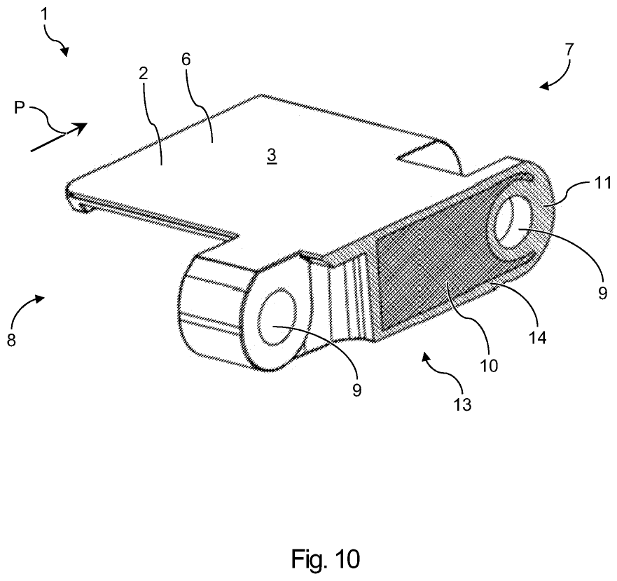

FIG. 10 shows a schematic perspective top view of a longitudinal cross section of the module of FIG. 7; and

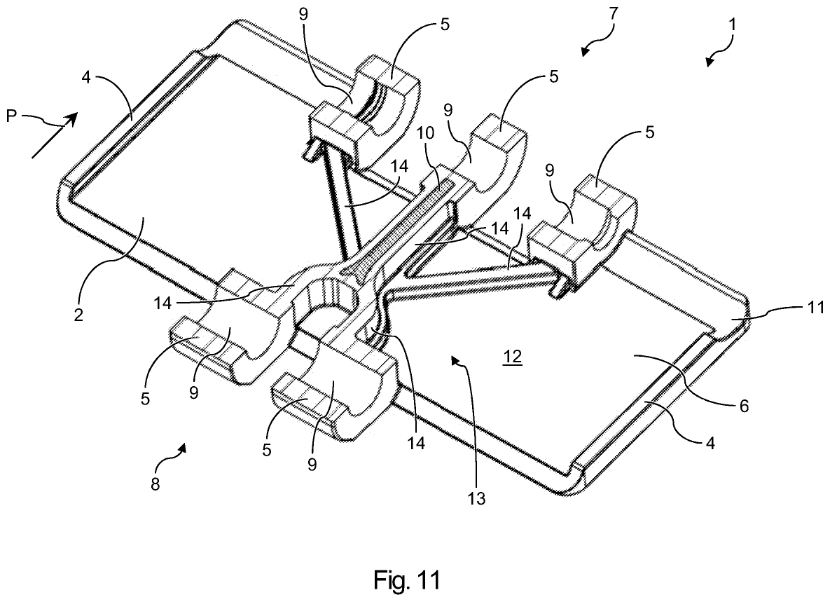

FIG. 11 shows a schematic perspective bottom view of a horizontal cross section of the module of FIG. 7.

It is noted that the drawings are only schematic representations of exemplary embodiments of the invention. In the drawings, identical or corresponding parts are represented with the same reference numerals.

FIGS. 1 through 6 show a conveyor belt module 1 for a modular conveyor belt. In this example, the modular conveyor belt is configured for a conveyor chain. The conveyor belt module 1 comprises a module body 2 with a top surface 3 for supporting products to be transported, and a bottom surface 4 for sliding over a conveying track. Link elements 5 extend outward from a central portion 6 of the body 2, in a conveying direction P at the front 7, and in opposite direction at the rear 8. The link elements are located below the central portion 6. The link elements 5 at the rear 8 are interspaced transversely to the conveying direction, such that link elements 5 of successive modules 1 may interdigitate. The link elements 5 have been provided with axially aligned hinge openings 9, so that successive modules 1 may be coupled with hinge pins (not shown) that extend transversely to the conveying direction P through the hinge openings 9. Successive module 1 bodies may be coupled so that top surfaces 3 of conveyor belt modules 1 can jointly form a conveying plane. The successive modules 1 may then hinge about an axis parallel to the conveying plane transversely to the conveying direction.

The injection molded body 2 includes recycled PET (rPET). In this example, the body 2 is wholly made of rPET. The rPET material of the body 2 is molded from rPET flakes that originate from shredded recycled post consumer PET bottles. The rPET material of the body 2 includes a black pigment to make the conveyor belt modules 1 uniform in color and opaque.

The rPET material of the conveyor belt module 1 has been injection molded in a mold cavity of an injection molding to present a varying degree of crystallinity across the body 2 of the module 1. In particular the body 2 comprises a core 10 having a relatively high average degree of crystallization, and an outer cover layer 11 of a relatively low average degree of crystallization. The material of the core 10 has a relatively high average degree of crystallization and is less amorphous, while the material of the cover layer 11 forms a skin having a relatively low average degree of crystallization and is more amorphous. The core 10, at least one or more sections thereof, here extends between the link elements 5 in a front-rear direction corresponding to the conveying direction P, see for example FIGS. 5, 3b and 3c. In FIGS. 1 to 6, for purposes of illustration the core 10 has been drawn in schematically and is not drawn to scale. In practice, the core may vary in thickness, and the core may be built up of several portions that may or may not interconnect. In this example, the outer cover layer 11 is substantially amorphous, and has an average degree of crystallinity of 3%. The core 10 is substantially crystalline, and has an average degree of crystallinity of 30% or less, preferably in the range of 5-10%, so higher than the average degree of crystallinity of the outer cover layer 11. Between the outer cover layer 11 and the core 10 a transient zone is present in which the crystallinity gradually increases (not shown in the schematic drawings).

The core 10 of the body 2 is relatively hard and brittle, while the outer layer 11 is relatively ductile and tough. In the example, the outer layer 11 forms a skin that has a minimum thickness of 1 mm and an average thickness of 1.5 mm. The outer layer 11 may be formed by providing enhanced cooling in the molding tool, e.g. additional cooling channels.

The link elements 5 have been molded to be substantially amorphous and have a relatively low average degree of crystallization compared to the central portion 6 of the body 2, e.g. less 10%, and have been made relatively tough and ductile so as to increase their capacity to withstand impact loads imparted during conveying or during assembly. This has been achieved by providing additional dedicated cooling channels near the areas of the mold cavity in which the link elements 5 were formed, and by cooling the core elements that form the hinge openings 9 in the link elements 5.

FIGS. 7-11 show a second embodiment. Apart from where the contrary follows from the present description and/or the figures, the above descriptions regarding the first embodiment may correspondingly apply to the second embodiment. In this exemplary embodiment, the material of the conveyor belt module is solid PET, e.g. virgin PET, rPET or a mixture thereof. The material of the conveyor belt module has been molded to present a varying degree of crystallinity across its body.

The module 1 according to the second embodiment can be seen to have two link elements 5 at a front side 7 and three link elements 5 at a rear side 8. On each side, the link elements 5 are mutually interspaced to allow front and rear link elements 5 of subsequent modules to interdigitate. Thus, the link elements 5 here all have a relatively small transverse width relatively compared to transversal ranges of the link elements 5 on the front and rear sides 7, 8 of the module 1. It can be seen that the widths of the link elements 5 at the front side 7 corresponds to an interspacing between the link elements 5 at the rear side 8, to provide interdigitation. The transverse width of the central link element 5 at the rear side 8 is small compared to the other link elements 5.

In the second embodiment, the core 10 forms a stiffener 10 extending between the link elements 5 in the front-rear direction. The core has an average degree of crystallization between 5 and 10%. Along a transverse or sideways direction of the module 1 the stiffener 10 is arranged centrally with respect to the link elements 5, in particular being formed substantially symmetrically with respect to a central plane extending in front-rear and top-bottom directions. The stiffener 10 extends into one of the link elements 5, in particular a central link element, here at a front side 7 of the module 1. The stiffener 10 is here embedded in a connecting structure 13 that interconnects the link elements 5. The connecting structure 13 comprises connecting ribs 14 connected to respective ones of the link elements 5, the connecting ribs 14 being mutually interconnected, in particular at the stiffener 10. Compared to the stiffener 10, the rest of the connecting structure 13 is substantially amorphous and/or has a relatively low average degree of crystallization, e.g. less than 3%, 2% or 1%. Due to its relatively high crystallisation, the PET material of the core is relatively stiff and brittle compared to more amorphous PET material of the rest of the body, which is more ductile and tough. The stiffness of the core allows to reduce elongation of the module in transport direction under the tensile load that acts on the module of the conveyor during operation. This way, elongation of the conveyor can be limited, and the module can keep its pitch, which e.g. facilitates its cooperation with sprocket wheels. Apart from the core 10 that here forms a stiffener 10, the rest of the body 2 of the module is here substantially amorphous, thus forming an outer cover layer 11 that substantially forms the module body 2 and in which the core 10 is embedded, here in particular fully enclosed. The amorphous material of the rest of the body 2 envelops the stiffener 10, and forms a skin that shields it against impact. In case of breakage, the amorphous material enveloping the stiffener 10 keeps the broken pieces together, so that operation can continue until a convenient time for replacement has arrived. In use, the connecting structure 13 assists to absorb the tensile load that is exerted on the link elements, and to transfer the tensile load to the stiffener 10.

The stiffener 10, and preferably the connecting structure 13, is formed on a bottom side of the module 1, in particular along a bottom face 12 that is recessed with respect to lateral outer body sections forming a bottom surface 4 for sliding over a conveying track, and/or with respect to the link elements 5. This way, the body 10 can have a relatively small general thickness, e.g. a thickness of about 2 mm, between the top surface and the recessed bottom face, which facilitates injection molding the conveyor belt module with a low general degree of crystallization apart from the core and/or stiffener. To suppress crystallization, parts of the mold cavity can be actively cooled, in particular at the link elements, to an average degree of crystallization of less than 3%, 2% or 1%. With respect to the average degree of crystallization it is observed that in practice, if a module of the example is molded from clear PET material, the body can be so amorphous that it is transparent to the naked eye in normal office lighting conditions, with only the stiffener being opaque.

The invention is not limited to any specific example given in this description. In this respect, it is observed that within this context, a modular conveyor belt having a single row of modules is meant to comprise a modular conveyor chain. In addition, it is observed that the conveyor belt module, modular conveyor and conveyor belt system may include any of the features set out in relation to the prior art in the introductory portion of the description. Further it is observed that the body of a conveyor belt module in accordance with the invention may in addition to rPET thus include virgin PET and/or other materials, e.g. fibres and/or other plastics—e.g. (thermoplastic) copolymers rubberized PCV, and that virgin PET could be used instead of rPET as well. Preferably, in view of recyclability, the body is substantially free from other materials than PET, in particular free from other polymers than PET. The belt module can present a material structure that is solid, as e.g. shown in the example above. In such a solid structure, the density of the conveyor module can be the same as the density of the polymeric material it is made of. In particular, the density of the conveyor module can thus be the density of the type of PET polymer material it is made of. The material of the body of the conveyor module can then be free of unoccupied volume, in contrast to when the module presents a material structure that is (micro) cellular. The plastics material used for molding can then be free of foaming agent, and the molded material can be unfoamed. The conveyor module body can then have a material structure that is closed and can be free of voids, in contrast to e.g. a conveyor module body having a material structure that is open, such as a (micro) cellular structure. Where the present disclosure indicates a maximum value for an average degree of crystallinity of an element or area, preferably the same maximum value applies to the degree of crystallinity itself throughout that element or area, in particular for elements or areas that are indicated as relatively amorphous compared to other elements or areas. Although modules are disclosed herein as having front and rear sides corresponding to a conveying direction, such a conveying direction could be reversed so that the designations of the front and rear sides could be mutually swapped. Many variations will be apparent to the person skilled in the art.

Such variations are understood to be comprised within the scope of the invention defined in the appended claims.

The present disclosure comprises the following numbered embodiments E1 to E23, each of which may be combined with any other embodiment disclosed herein, at least where the present disclosure does not indicate or imply the contrary.

E1. A conveyor belt module for a modular conveyor belt having an injection molded body that includes recycled PET (rPET) and/or virgin PET.

E2. The conveyor belt module of E1, wherein the body is a solid body.

E3. The conveyor belt module of E1 or E2, wherein the body comprises a top surface for supporting products to be transported, a bottom surface for sliding over a conveying track, and link elements at a front and rear of the body for coupling to a consecutive conveyor belt module.

E4. The conveyor belt module of any of E1-E3, wherein the body includes at least 40 weight %, specifically more than 50 weight % and in particular more than 60 weight % of PET, in particular rPET.

E5. The conveyor belt module of any of E1-E4, wherein the material of the conveyor belt module has been molded to present a varying degree of crystallinity across its body.

E6. The conveyor belt module of E5, wherein the body comprises a core having a relatively high average degree of crystallization, and an outer cover layer of a relatively low average degree of crystallization.

E7. The conveyor belt module of E6, wherein the outer cover layer is substantially amorphous, e.g. having an average degree of crystallinity of less than 20 or 10%, and/or the core is substantially crystalline, e.g. having an average degree of crystallinity of at least 20%, e.g. 30 or 40%.

E8. The conveyor belt module of E6 or E7, wherein the outer cover layer has a minimum thickness of at least 1 mm, preferably 2 mm, and/or an average thickness of e.g. at least 1.5 as measured perpendicular to its surface.

E9. The conveyor belt module of any of E6-E8, wherein the core, at least a section thereof, extends between the link elements in a front-rear direction corresponding to a conveying direction.

E10. The conveyor belt module of any of E1-E9, wherein the coupling elements are substantially amorphous and/or have a relatively low average degree of crystallization, e.g. less than 30 or 10%.

E11. The conveyor belt module of any of E1-E10, wherein rPET material of the body originates from recycled PET bottles.

E12. The conveyor belt module of E11, wherein the PET, in particular rPET, material is processed without adding nucleating agent.

E13. The conveyor belt module of any of E1-E12, wherein rPET material of the body is molded from rPET flakes, preferably rPET flakes obtained from shredded postconsumer bottles.

E14. The conveyor belt module of any of E1-E13, wherein rPET material of the body is molded from multicolor rPET flakes, preferably multicolor rPET flakes obtained from shredded postconsumer bottles.

E15. The conveyor belt module of any of E1-E14, wherein rPET material of the body includes a pigment to make the conveyor belt modules uniform in color and/or substantially opaque, preferably a dark pigment.

E16. The conveyor belt module of any of E1-E15, wherein the rPET material of the body includes fibers and/or copolymers.

E17. The conveyor belt module of any of E1-E16, wherein the link elements extend outward from a central portion of the body, in a conveying direction at the front, and in opposite direction at the rear.

E18. The conveyor belt module of any of E1-E17, wherein link elements are interspaced transversely to the conveying direction, such that link elements of successive modules may interdigitate.

E19. The conveyor belt module of any of E1-E18, wherein link elements are provided with aligned hinge openings therein, so that successive modules may be coupled with hinge pins that extend transversely to the conveying directions.

E20. A modular conveyor belt comprising a row of modules extending in conveying direction, wherein successive modules are hingedly coupled about an axis in or parallel to a conveying plane transversely to the conveying direction so that the modules can rotate relative to each other, said row of modules comprising one or more modules according to any of E1-E19.

E21. A conveyor system including a modular conveyor belt according to E20, in which the conveyor belt modules are coupled to form an endless loop, and wherein a top run of the modular conveyor belt is arranged to circulate over a conveying track that extends in a conveying direction between return elements, and wherein a bottom run of the modular conveyor belt is arranged to circulate over a return track that extends in opposite direction between the return elements.

E22. Use of PET, including recycled PET (rPET) and/or virgin PET, for molding a conveyor belt module for a modular conveyor belt, in particular a conveyor belt module in accordance to any of E1-E19.

E23. A method of manufacturing a conveyor belt module for a modular conveyor belt, in particular a conveyor belt module in accordance to any of E1-E19, in which PET, including recycled PET (rPET) and/or virgin PET, is injected in a mold cavity to form a body of the module.

### LIST OF REFERENCE SIGNS

1. Conveyor belt module

2. Module body

3. Top surface

4. Bottom surface

5. Link elements

6. Central portion

7. Front

8. Rear

9. Hinge openings

10. Core, stiffener

11. Outer cover layer

12. Recessed bottom face

13. Connecting structure

14. Connecting ribs

P Conveying direction

1. A conveyor belt module for a modular conveyor belt having an injection molded body that includes recycled PET (rPET) and/or virgin PET.

2. The conveyor belt module of claim 1, wherein the body is a solid body.

3. The conveyor belt module of claim 1, wherein the body comprises a top surface for supporting products to be transported, a bottom surface for sliding over a conveying track, and link elements at a front and rear of the body for coupling to a consecutive conveyor belt module.

4. The conveyor belt module of claim 1, wherein the body includes at least 40 weight % of PET.

5. The conveyor belt module of claim 1, wherein the material of the conveyor belt module has been molded to present a varying degree of crystallinity across its body.

6. The conveyor belt module of claim 5, wherein the body comprises a core having a relatively high average degree of crystallization, and an outer cover layer of a relatively low average degree of crystallization.

7. The conveyor belt module of claim 6, wherein the outer cover layer is substantially amorphous, having an average degree of crystallinity of less than 5%, and the core is more crystalline than the outer cover layer, having an average degree of crystallinity of at least 5%.

8. The conveyor belt module of claim 7, wherein the core has an average degree of crystallinity of less than 20%.

9. The conveyor belt module of claim 6, wherein the outer cover layer has a minimum thickness of at least 1 mm and/or an average thickness of at least 1.5 mm as measured perpendicular to its surface.

10. The conveyor belt module of claim 6, wherein the core, at least a section thereof, extends between the link elements in a front-rear direction corresponding to a conveying direction.

11. The conveyor belt module of claim 10, wherein the core, at least a section thereof, forms a stiffener extending between the link elements in the front-rear direction.

12. The conveyor belt module of claim 11, wherein along a transverse, in particular sideways, direction of the module the stiffener is arranged centrally with respect to the link elements, in particular-being formed substantially symmetrically with respect to a central plane extending in front-rear and top-bottom directions.

13. The conveyor belt module of claim 11, wherein the stiffener extends into one of the link elements, in particular a central link element.

14. The conveyor belt module of claim 11, wherein the stiffener is embedded in a connecting structure that interconnects at least two of the link elements and wherein the connecting structure comprises connecting ribs connected to respective ones of the link elements, the connecting ribs being mutually interconnected.

15. (canceled)

16. The conveyor belt module of claim 14, wherein, compared to the stiffener, the rest of the connecting structure is substantially amorphous and/or has a relatively low average degree of crystallization, of less than 10%.

17. The conveyor belt module of any of claim 11, wherein the stiffener, is formed on a bottom side of the module, in particular along a bottom face that is recessed with respect to lateral outer body sections forming a bottom surface for sliding over a conveying track, and/or with respect to the link elements.

18. The conveyor belt module of claim 11, wherein, apart from the core and/or the stiffener, link elements are substantially amorphous and/or have a relatively low average degree of crystallization, in particular compared to the core and/or the stiffener, with a degree of crystallization of less than 10%.

19-23. (canceled)

24. A modular conveyor belt comprising a row of modules extending in conveying direction, wherein successive modules are hingedly coupled about an axis in or parallel to a conveying plane transversely to the conveying direction so that the modules can rotate relative to each other, said row of modules comprising one or more modules according to claim 1.

25. A conveyor system including a modular conveyor belt according to claim 24, in which the conveyor belt modules are coupled to form an endless loop, and wherein a top run of the modular conveyor belt is arranged to circulate over a conveying track that extends in a conveying direction between return elements, and wherein a bottom run of the modular conveyor belt is arranged to circulate over a return track that extends in opposite direction between the return elements.

26. (canceled)

27. A method of manufacturing a conveyor belt module for a modular conveyor belt in accordance to claim 1, the method comprising injecting recycled PET (rPET) and/or virgin PET in a mold cavity to form a body of the module and wherein parts of the mold cavity are actively cooled to suppress crystallization, in particular at the link elements, in particular to an average degree of crystallization of less than 10%.

28-29. (canceled)
